(19) United States
(12) Patent Application Publication
(10) Pub. No.: US 2026/0212704 A1
(43) Pub. Date: Jul. 23, 2026

(54) ANALYSIS METHOD AND SYSTEM FOR BIRD BEHAVIOR BASED ON MULTI-FRAME FUSION

(71) Applicant: Tuopu Weishi Shenzhen Technology Co., Ltd., Shenzhen (CN)

(72) Inventors: Shicong Yuan, Shaoyang (CN); Zhen Li, Shaoyang (CN)

(21) Appl. No.: 19/463,181

(22) Filed: Jan. 29, 2026

(30) Foreign Application Priority Data
Nov. 6, 2025 (CN) 202511613223.X

(51) Int. Cl. G06V 40/20; G06V 20/52

(52) U.S. Cl. CPC G06V 40/20; G06V 20/52

(57) ABSTRACT

An analysis method for bird behavior based on multi-frame fusion, including: performing a dual-channel monitoring and a frame rate fusion based on a monitoring device assembled inside a housing of a binocular bird feeder, to determine an image frame sequence, a behavior structure is defined in a lightweight geometric linear manner using a head-neck-beak of a bird as a basis for frame rate fusion. Constructing a behavior analysis module using behavioral semantics, behavioral micro-actions, and macroscopic composite behaviors as recognition dimensions, performing a dimension-parallel analysis and a statistical analysis on the image frame sequence to determine bird behavior data. Performing a periodic monitoring analysis and updating the bird behavior data, the bird behavior data that has stabilized is used as a behavior analysis result for display on a terminal interface.

### CROSS REFERENCE TO RELATED APPLICATIONS

This application claims foreign priority of Chinese Patent Application No. 202511613223.X, filed on Nov. 6, 2025 in the China National Intellectual Property Administration, the disclosures of all of which are hereby incorporated by reference.

### TECHNICAL FIELD

The present disclosure relates to the technical field of image recognition, in particular to an analysis method and system for bird behavior based on multi-frame fusion.

### BACKGROUND

In existing bird behavior observation practices, a single camera or non-cooperative multiple cameras are typically deployed around a bird feeder. Each monitoring viewpoint operates independently, resulting in fragmented spatiotemporal data acquisition. This makes it difficult to continuously and completely capture the trajectories of sequential bird behaviors such as feeding and drinking. Due to the high flexibility of bird body posture, subtle movements, and frequent activity, a single viewpoint is prone to occlusion, loss of critical pose features, and tracking failures. Consequently, the acquired monitoring data is discontinuous, the granularity of behavior recognition remains low, and analysis is generally limited to determining the approximate activity range of birds. It is not possible to resolve fine-grained behaviors that carry explicit ecological significance, thereby compromising the accuracy and reliability of behavior recognition.

In summary, the prior art suffers from the technical problem that the lack of cooperative multi-view perception and the fragmentation of monitoring data lead to insufficient behavior recognition accuracy, which in turn adversely affects the accuracy and reliability of bird behavior analysis.

### SUMMARY

The present disclosure aims to provide an analysis method for bird behavior based on multi-frame fusion, so as to address the technical problem existing in the prior art the lack of cooperative multi-frame perception and the fragmentation of monitoring data result in insufficient behavior recognition accuracy, thereby further impacting the accuracy and reliability of bird behavior analysis.

To realize the above objective, the present disclosure provides an analysis method for bird behavior based on multi-frame fusion, including: performing a dual-channel monitoring and a frame rate fusion based on a monitoring device assembled inside a housing of a binocular bird feeder, to determine an image frame sequence, a behavior structure is defined in a lightweight geometric linear manner using a head-neck-beak of a bird as a basis for frame rate fusion; constructing a behavior analysis module using behavioral semantics, behavioral micro-actions, and macroscopic composite behaviors as recognition dimensions, performing a dimension-parallel analysis and a statistical analysis on the image frame sequence to determine bird behavior data; performing a periodic monitoring analysis and updating the bird behavior data, the bird behavior data that has stabilized is used as a behavior analysis result for display on a terminal interface.

Furthermore, the monitoring device includes a first camera and a second camera, with a food tray and a water tray serving as a monitoring range; before performing a dual-channel monitoring and a frame rate fusion based on a monitoring device assembled inside a housing of a binocular bird feeder further includes: performing a time-sequence synchronization constraint on the monitoring device based on an absolute clock.

Furthermore, performing a dual-channel monitoring and a frame rate fusion based on a monitoring device assembled inside a housing of a binocular bird feeder, to determine an image frame sequence includes: obtaining back dual-channel image sequences acquired by the monitoring device; determining component relationships under a behavior structure constraint, the component relationships are constituted by a set of ternary geometric linear structures based on head-neck-beak constraints of different bird behaviors; establishing a frame rate fusion component based on the component relationships, performing effective frame rate screening and time-series interleaving integration on the dual-channel image sequences based on matching and switching of the component relationships, to obtain the image frame sequence.

Furthermore, constructing a behavior analysis module using behavioral semantics, behavioral micro-actions, and macroscopic composite behaviors as recognition dimensions includes: constructing a first analysis pathway based on behavioral semantic recognition of component relationships; constructing a second analysis pathway based on single-behavior micro-action recognition; constructing a third analysis pathway based on macroscopic composite behavior recognition; performing a parallel processing of the first analysis pathway, the second analysis pathway, and the third analysis pathway and establishing a lateral interaction therebetween as the behavior analysis module, the behavior analysis module is set as an embedded plug-in at a backend of the binocular bird feeder.

Furthermore, before performing a periodic monitoring analysis, the analysis method for bird behavior based on multi-frame fusion further includes: marking key single frame images in the image frame sequence under switching constraints of the component relationships using a first identifier; importing the marked image frame sequence into the behavior analysis module to perform bird behavior analysis.

Furthermore, performing a periodic monitoring analysis includes: performing an image frame localization on the first analysis pathway using the first identifier, and executing a behavioral semantic interpretation based on ternary geometric linear structures under the component relationships to determine a first analysis result; laterally interacting the first analysis result to the second analysis pathway and the third analysis pathway, performing a targeted recognition based on micro-actions and macroscopic composite behaviors, and determining a second analysis result and a third analysis result.

Furthermore, the second analysis pathway takes an image frame group of a single behavior as one recognition unit and performs partition parallel analysis based on a single recognition unit; the third analysis pathway performs a macroscopic grouping constraint on image frame groups based on behavior correlation and performs a partition parallel analysis based on a macroscopic grouping.

Furthermore, performing a statistical analysis on the image frame sequence to determine bird behavior data includes: constructing a behavior chain based on the first analysis result, the second analysis result, and the third analysis result; performing the statistical analysis on the behavior chain according to statistical mining rules of behavior patterns and bird behaviors to determine bird behavior data.

Furthermore, the analysis method for bird behavior based on multi-frame fusion further includes: collecting cross-modal data, the cross-modal data includes at least an audio time stream and environmental elements; aligning the behavior chain with the audio time stream and performing the statistical analysis; compensating the bird behavior data according to the environmental elements.

The present disclosure further provides an analysis system for bird behavior based on multi-frame fusion, the analysis system for bird behavior based on multi-frame fusion is configured to implement the steps of the analysis method for bird behavior based on multi-frame fusion mentioned above, the analysis system for bird behavior based on multi-frame fusion including: an image frame sequence determination module, performing a dual-channel monitoring and a frame rate fusion based on a monitoring device assembled inside a housing of a binocular bird feeder, to determine an image frame sequence, a behavior structure is defined in a lightweight geometric linear manner using a head-neck-beak of the bird as a basis for frame rate fusion; an image analysis module, constructing a behavior analysis module using behavioral semantics, behavioral micro-actions, and macroscopic composite behaviors as recognition dimensions, performing a dimension-parallel analysis and a statistical analysis on the image frame sequence to determine bird behavior data; a behavior analysis module, performing a periodic monitoring analysis and updating the bird behavior data, the bird behavior data that has stabilized is used as a behavior analysis result for display on a terminal interface.

The present disclosure further provides a non-transitory computer-readable storage medium, the non-transitory computer-readable storage medium stores an analysis program for bird behavior based on multi-frame fusion, when the analysis program for bird behavior based on multi-frame fusion is executed by a processor, implements the steps of the analysis method for bird behavior based on multi-frame fusion mentioned above.

One or more technical solutions provided in this application have at least the following technical effects or advantages: performing a dual-channel monitoring and a frame rate fusion based on a monitoring device assembled inside a housing of a binocular bird feeder, to determine an image frame sequence, a behavior structure is defined in a lightweight geometric linear manner using a head-neck-beak of the bird as a basis for frame rate fusion; constructing a behavior analysis module using behavioral semantics, behavioral micro-actions, and macroscopic composite behaviors as recognition dimensions, performing a dimension-parallel analysis and a statistical analysis on the image frame sequence to determine bird behavior data; performing a periodic monitoring analysis and updating the bird behavior data, the bird behavior data that has stabilized is used as a behavior analysis result for display on a terminal interface. In other words, dual-channel monitoring and frame rate fusion are performed by the monitoring device, and the behavior analysis module is constructed to conduct multi-dimensional behavior patterns parsing and iterative updating on the image frame sequence, thereby improving the precision of bird behavior recognition and consequently enhancing the accuracy and reliability of bird behavior analysis.

The foregoing description merely provides an overview of the technical solutions of the present disclosure. To enable a clearer understanding of the technical means of the present disclosure and to implement them in accordance with the content of the specification, and to make the above and other objectives, features, and advantages of the present disclosure more apparent and comprehensible, specific embodiments of the present disclosure are set forth below. It should be understood that the content described in this section is not intended to identify key or essential features of the embodiments of the present disclosure, nor is it intended to limit the scope of the present disclosure. Other features of the present disclosure will become readily apparent from the following description in the specification.

### BRIEF DESCRIPTION OF THE DRAWINGS

To more clearly illustrate the technical solutions of the present disclosure or those in the prior art, a brief introduction is given below to the drawings required for describing the embodiments or the prior art. It is apparent that the drawings described below are merely exemplary. A person of ordinary skill in the art may, without creative effort, obtain other drawings based on the provided drawings.

FIG. 1 is a flowchart of the overall process of an analysis method for bird behavior based on multi-frame fusion according to the present disclosure.

FIG. 2 is a flowchart of the analysis method for bird behavior based on multi-frame fusion according to an embodiment of the present disclosure.

FIG. 3 is a schematic structural diagram of a binocular bird feeder according to the present disclosure.

FIG. 4 is a first detailed flowchart of the analysis method for bird behavior based on multi-frame fusion according to an embodiment of the present disclosure.

FIG. 5 is a second detailed flowchart of the analysis method for bird behavior based on multi-frame fusion according to an embodiment of the present disclosure.

FIG. 6 is a third detailed flowchart of the analysis method for bird behavior based on multi-frame fusion according to an embodiment of the present disclosure.

FIG. 7 is a fourth detailed flowchart of the analysis method for bird behavior based on multi-frame fusion according to an embodiment of the present disclosure.

FIG. 8 is a fifth detailed flowchart of the analysis method for bird behavior based on multi-frame fusion according to an embodiment of the present disclosure.

FIG. 9 is a schematic diagram of the analysis system for bird behavior based on multi-frame fusion according to the present disclosure.

FIG. 10 is a schematic diagram of a hardware structure of an analysis apparatus for bird behavior based on multi-frame fusion involved in various embodiments of the present invention.

### DESCRIPTION OF THE REFERENCE NUMERAL

11 image analysis module, 12 behavior analysis module, 1 housing, 2 food tray, 3 through hole, 4 water tray, 5 sealing plug, 6 perch frame.

### DETAILED DESCRIPTION OF THE EMBODIMENTS

The present disclosure provides an analysis method for bird behavior based on multi-frame fusion, which addresses the technical problems in the prior art, namely, insufficient behavior recognition accuracy resulting from the lack of collaborative multi-perspective perception and fragmented monitoring data, which in turn affects the accuracy and reliability of bird behavior analysis. By employing a monitoring device to perform dual-channel monitoring and frame rate fusion, and by constructing a behavior analysis module to conduct multi-dimensional behavior parsing and updating on image frame sequence, the accuracy of bird behavior recognition is improved, thereby enhancing the accuracy and reliability of bird behavior analysis.

Hereinafter, the technical solutions of the present disclosure will be clearly and completely described with reference to the accompanying drawings. It is apparent that the embodiments described are only some, rather than all, of the embodiments of the present disclosure. It should be understood that the present disclosure is not limited to the exemplary embodiments described herein. Based on the embodiments of the present disclosure, all other embodiments obtained by a person of ordinary skill in the art without making creative efforts shall fall within the protection scope of the present disclosure. It should also be noted that, for convenience of description, the drawings only show the parts relevant to the present disclosure and not the entire structure.

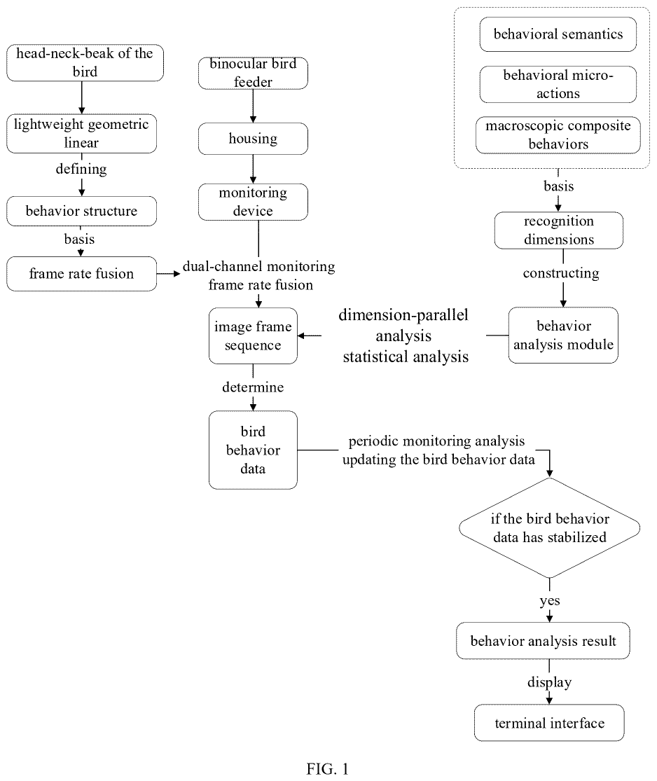

Referring to FIG. 1, an embodiment of the present disclosure provides an analysis method for bird behavior based on multi-frame fusion, the analysis method is applied to an analysis system for bird behavior based on multi-frame fusion.

Multi-frame fusion refers to a process of combining multiple image frames (usually consecutive or closely related) to create one superior composite image by exploiting the redundant and complementary information across frames.

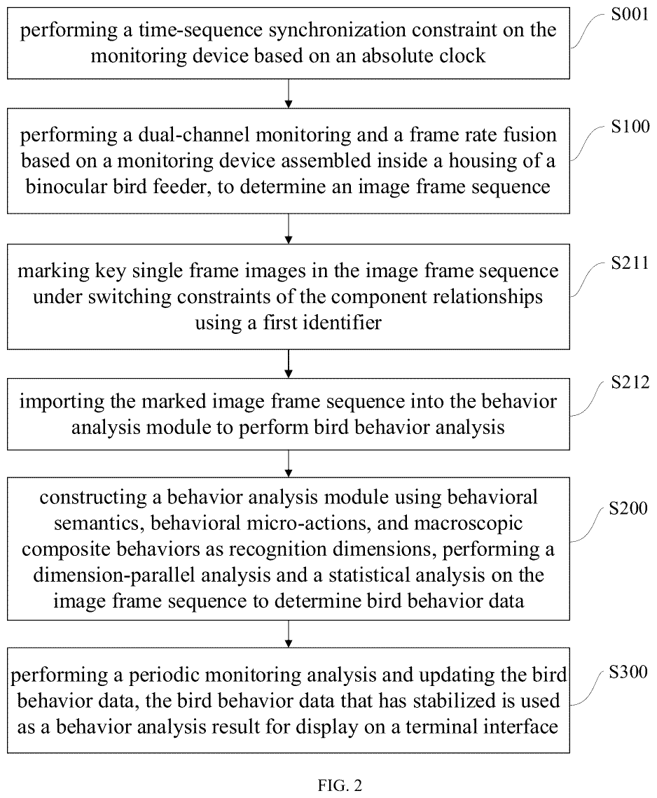

Please refers to FIG. 2, the analysis method specifically includes the following steps of S100 to S300.
S100, performing a dual-channel monitoring and a frame rate fusion based on a monitoring device assembled inside a housing of a binocular bird feeder, to determine an image frame sequence, a behavior structure is defined in a lightweight geometric linear manner using a head-neck-beak of a bird as a basis for frame rate fusion.

The monitoring device includes a first camera and a second camera, with a food tray and a water tray serving as a monitoring range. Before S100, the analysis further includes S001, performing a time-sequence synchronization constraint on the monitoring device based on an absolute clock.

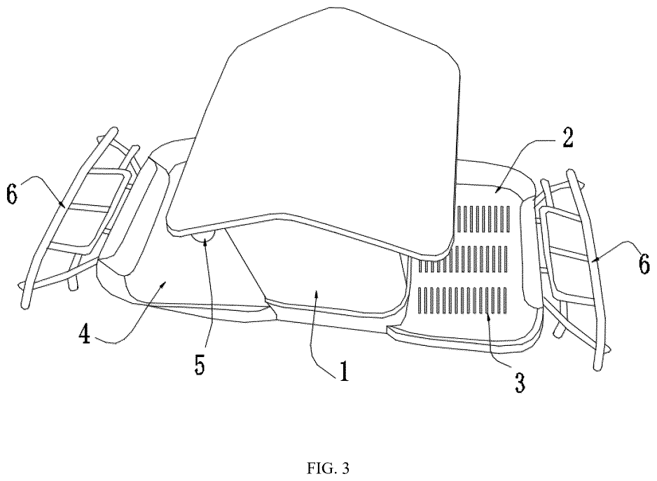

More specifically, as shown in FIG. 3, the binocular bird feeder is an outdoor bird-feeding device serving as a platform for carrying water and food for consumption by birds. The binocular bird feeder includes a housing 1, a food tray 2, a water tray 4, and perch frames 6. The monitoring device is installed at a bottom of the housing 1 and is oriented toward the food tray 2 and the water tray 4. The food tray 2 and the water tray 4 are respectively fixed to two sides of the bottom of the housing 1 and are arranged symmetrically. Perch frames 6 are fixedly mounted on outer sides of both the food tray 2 and the water tray 4. A plurality of through holes 3 are formed in a bottom of the food tray 2, the through holes 3 are uniformly distributed across the bottom of the food tray 2, with a width of 1-3 mm. When birds feed, due to the pointed structure of their beaks, biting forces are exerted on the food, resulting in food fragmentation and the generation of residue or powder. Such food residue or powder falls downward through the through holes 3 without accumulating in the food tray 2. Moreover, the through holes 3 provide a drainage function, allowing rainwater in the food tray 2 to drain downward during rainy conditions, thereby preventing water accumulation in the food tray 2. The water tray 4 is provided with drainage holes, each drainage hole is fitted with a sealing plug 5 made of rubber material. The sealing plug 5 enables sealing of the drainage hole to prevent leakage. When it is necessary to clean wastewater from the water tray 4, the sealing plug 5 may be removed, allowing residual water in the water tray 4 to flow out directly through the drainage holes.

The monitoring device includes a first camera and a second camera oriented toward the food tray 2 and the water tray 4, respectively, so as to cover the entire area of both the food tray 2 and the water tray 4. The monitoring device simultaneously activates dual-channel video acquisition, that is, starts the first camera and the second camera to acquire two independent video streams in parallel. The first camera and the second camera perform time synchronization based on an absolute clock, ensuring precise temporal alignment of the dual-channel image frames. The absolute clock serves as a high-precision, unified time reference source (such as a global positioning system (GPS) clock or a network time protocol (NTP)), and assigns each image frame captured by the two cameras with a timestamp having absolute significance and mutual comparability.

The temporal co-frequency constraint is a synchronization control strategy that ensures the two cameras not only start recording simultaneously, but also maintain strictly consistent acquisition frequencies throughout the entire acquisition process, with the exposure instants of each frame precisely aligned on the time axis, thereby avoiding time drift caused by hardware differences. The first camera and the second camera within the monitoring device operate at the same frame rate and are subject to the temporal co-frequency constraint of the absolute clock, ensuring that from the first second onward, the two video streams are aligned on the same precise time axis. During the data acquisition process, a high-precision timestamp (accurate to the millisecond level) is embedded in each image frame.

The behavior structure is defined in the lightweight geometric linear manner using the head-neck-beak of the bird as a basis for frame rate fusion. The complex head, neck, and beak structures of the bird are simplified into a two-dimensional or three-dimensional polyline connected by a plurality of key articulation points. Identifying key action component relationship according to the behavior structure constraint, and performing screening and consolidation of redundant frames, occluded frames, and non-key frames. Interleaving dual-channel frames according to their timestamps to form a continuous and complete image frame sequence. Determining occurrence of a cross-region behavior event when the head-neck-beak behavior structure in a first camera view exhibits a posture of head raising followed by turning toward a second camera, and substantially simultaneously—within an extremely short time difference—the neck-extended posture appears in the second camera view. Using the cross-region behavior event as a switching trigger point, automatically switching the video source from the first camera to the second camera and seamlessly inserting frames from the second camera into the sequence, thereby generating a smooth, cross-physical-field-of-view image frame sequence that completely records the continuous process.

Exemplarily, both the first camera (food tray) and the second camera (water tray) capture video at 15.000 frames per second with a resolution of 1920×1080, timestamp error per frame is less than 1 ms. When a bird completes its final pecking action in the food tray view at 09:15:32.456, the head-neck-beak geometric polyline indicates that the neck forms an angle of 65° with the horizontal plane, exhibiting a typical head-raising posture. At 09:15:32.489, the same bird appears at the edge of the water tray view, with the geometric polyline showing a neck angle of 15°, exhibiting a preparatory head-lowering posture. Upon recognizing that the time difference between these two events is only 33 ms and that the posture transition conforms to the flight logic from food tray to water tray, the current frame from the first camera and the current frame from the second camera are directly concatenated in the image frame sequence. The entire integration process generates an effective image frame sequence of 847 frames for this visit of the bird, seamlessly covering its complete residence period of approximately 28 seconds, including 19 seconds at the food tray and the subsequent 9 seconds of drinking at the water tray.

By employing an absolute clock synchronization and temporal co-frequency constraint, intrinsic contradictions arising from hardware asynchrony across multiple data channels are fundamentally eliminated at the source. The introduction of the lightweight geometric linear definition of the head-neck-beak structure as the basis for frame rate fusion shifts the core of data processing from the cameras to the bird's actual behavior itself, such that the output image frame sequence constitutes a true genuine behavioral narrative storyline, rather than a mere concatenation or simple stitching of video streams.

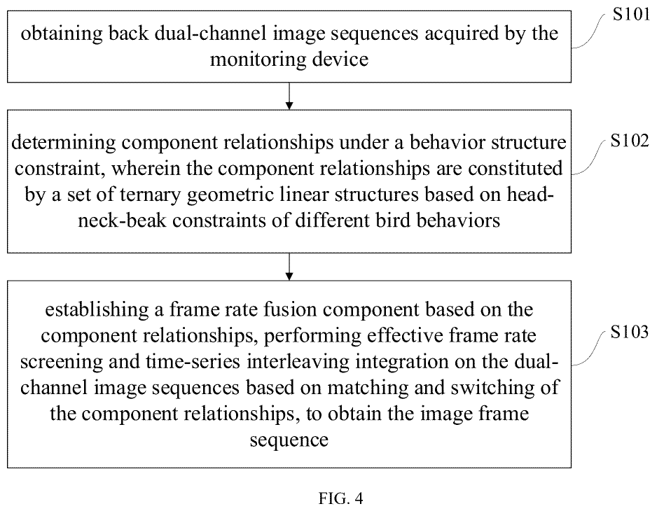

As shown in FIG. 4, the step of performing a dual-channel monitoring and a frame rate fusion based on a monitoring device assembled inside a housing of a binocular bird feeder, to determine an image frame sequence includes the following steps of S101 to S103: S101, obtaining back dual-channel image sequences acquired by the monitoring device; and S102, determining component relationships under a behavior structure constraint, the component relationships are constituted by a set of ternary geometric linear structures based on head-neck-beak constraints of different bird behaviors; and S103, establishing a frame rate fusion component based on the component relationships, performing effective frame rate screening and time-series interleaving integration on the dual-channel image sequences based on matching and switching of the component relationships, to obtain the image frame sequence.

Specifically, the monitoring device transmitting the dual-channel image sequences, corresponds to wirelessly transmitting raw dual-channel video data captured by a front-end monitoring device to a back-end server or edge computing node. The dual-channel image sequences consist of two independent, time-ordered image frame streams acquired by the first camera and the second camera, respectively, and subjected to temporal co-frequency constraint.

Utilizing the behavior structure based on the ternary geometric linear structures based on head-neck-beak constraints, component relationship recognition is performed on each frame so as to extract the head, neck, and beak key points of the bird in each frame and compute its current geometric linear structure in real time. The component relationships are not a single relation but a collection including various standard geometric linear structures presented by the head-neck-beak ternary structure of the bird under different typical behaviors. For example, a component relationship corresponding to drinking behavior is characterized by neck curvature with the beak pointing downward and contacting the water surface; a component relationship corresponding to alert behavior is characterized by an extended neck with rapid head rotation.

Based on the component relationships, a frame rate fusion module is established to intelligently screen and splice the dual-channel image sequences, remove invalid frames, and generate a continuous and effective time-series frame sequence. The dual-channel image sequences are mapped to a single-channel behavioral time-series frame rate, for behavioral conflicts that cannot coexist in the same time period (for example, a bird cannot feed and drink simultaneously), frames matching the behavior structure are preferentially retained while information-invalid frames—such as occluded frames or redundant frames—are discarded. Key frames selected according to timestamps are interleaved and integrated in chronological order to form a continuous, single-channel behavioral image frame sequence. The effective frame rate screening includes retaining—within the dual-channel video streams—only those image frames exhibiting bird postures of analytical value for behavior, while discarding blank shots, severely occluded frames, incomplete postures, or blurred frames; in particular, frames best representing behavioral characteristics immediately before and after a switch are retained, and the video source is decisively switched from the food tray camera to the water tray camera. The temporal interleaving integration includes arranging all screened effective frames carrying precise timestamps in chronological order. Through the effective frame rate screening, logically impossible behavioral conflicts within the same time period are eliminated, ensuring behavioral sequence reasonableness.

Through key frame screening and temporal interleaving integration, a single-channel continuous behavioral frame sequence is generated, thereby resolving the problem of fragmented monitoring.
S200, constructing a behavior analysis module using behavioral semantics, behavioral micro-actions, and macroscopic composite behaviors as recognition dimensions, performing a dimension-parallel analysis and a statistical analysis on the image frame sequence to determine bird behavior data.

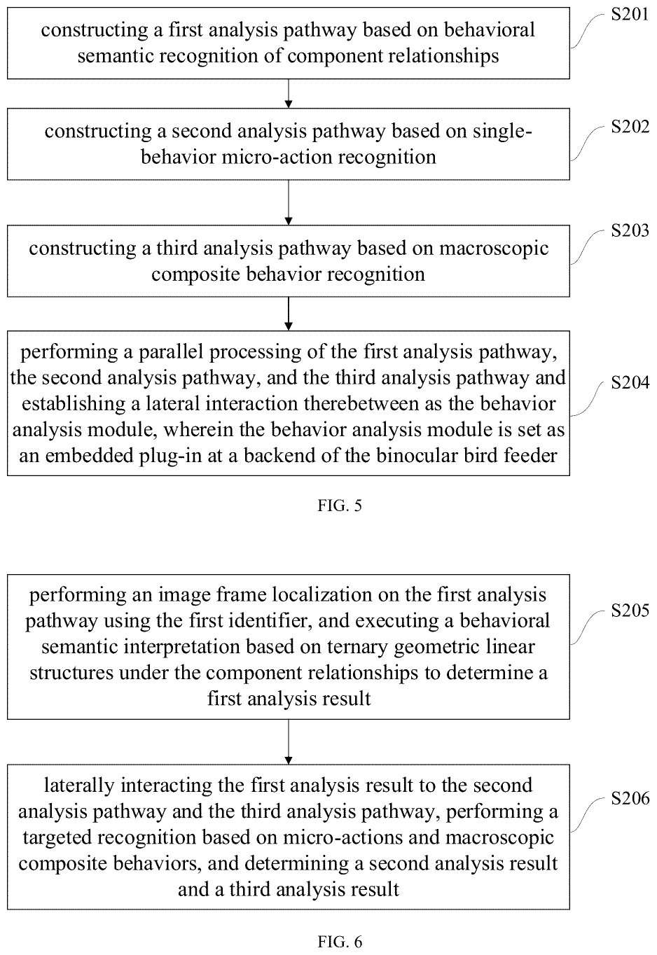

As shown in FIG. 5, the step of constructing a behavior analysis module using behavioral semantics, behavioral micro-actions, and macroscopic composite behaviors as recognition dimensions includes the following steps: S201, constructing a first analysis pathway based on behavioral semantic recognition of component relationships; S202, constructing a second analysis pathway based on single-behavior micro-action recognition; S203, constructing a third analysis pathway based on macroscopic composite behavior recognition; S204, performing a parallel processing of the first analysis pathway, the second analysis pathway, and the third analysis pathway and establishing a lateral interaction therebetween as the behavior analysis module, the behavior analysis module is set as an embedded plug-in at a backend of the binocular bird feeder.

Specifically, S201 includes: utilizing the relative positional relationship of the ternary geometric linear structures consisting of head-neck-beak of the bird to interpret the semantic meaning of the bird's behavior. For example, to determine whether the bird is performing a macroscopic action such as feeding, drinking, or perching.
S202 includes: analyzing fine-grained micro-actions under a single behavior. For example, decomposing a pecking action into a plurality of micro-temporal sub-stages including localization, slight beak opening and closing, pecking strike, grasping, and swallowing, and further analyzing the frequency, duration, and intensity of the micro-actions.
S203 includes: on a longer time scale, combining and recognizing a plurality of distinct basic behaviors according to their occurrence sequence, logical relationship, and statistical patterns, so as to identify bird behavior.
S204 includes: the three analysis pathways operate simultaneously without blocking each other, performing different-dimensional analysis on the same image frame sequence concurrently, such that semantic analysis, micro-action analysis, and macro-composite behavior analysis can mutually correct and supplement one another, thereby improving overall recognition accuracy. The parallel execution means that the three pathways process the same segment of image frame sequence simultaneously without waiting for each other. The lateral interaction means that, during the parallel processing, intermediate computation results and decision information are exchanged among the pathways to perform mutual correction and triggering, thereby forming a cooperative analysis network.

The behavior analysis module is an integrated software module that incorporates the three analysis pathways and their lateral interaction mechanism, and is configured to extract bird behavior features and behavior information from the image frame sequence. The behavior analysis module is implemented as an embedded plug-in at the rear end of the binocular bird feeder for analyzing the image frame sequence. By simultaneously recognizing macroscopic semantics, micro-actions, and composite behaviors, fine-grained and multi-level analysis is achieved.

Further, further refers to FIG. 2, the analysis method further includes the following steps: S211, marking key single frame images in the image frame sequence under switching constraints of the component relationships using a first identifier; S212, importing the marked image frame sequence into the behavior analysis module to perform bird behavior analysis.

Specifically, after obtaining the image frame sequence, key single frame images are identified and extracted according to switching constraints of component relationships. Under different behavioral states of the bird, the relative positional relationship (i.e., geometric structure) among the head, neck, and beak undergoes significant changes. Upon detecting an instant satisfying a switching constraint—for example, the bird disappearing from the food tray area while its posture indicates movement toward the water tray—a most representative key single frame image is selected from frames immediately before and after said event point. A structured first identifier is generated, containing the behavioral semantics at that moment, timestamp, and event type, and the first identifier is attached to the corresponding image frame.

The key single frame image refers to an image frame, within a continuous video frame sequence, that exhibits critical behavioral features as identified through switching of component relationships. The first identifier is a metadata tag used for marking key single frame images. It is not merely a simple mark but a structured data object typically including mark type, timestamp, associated behavioral semantics, source camera, and the like.

The marked image frame sequence is imported into the behavior analysis module for bird behavior analysis. The first analysis pathway, second analysis pathway, and third analysis pathway of the behavior analysis module rapidly scan the first identifiers upon receiving the image frame sequence, and respectively perform behavioral recognition, micro-action analysis, and statistical analysis of macroscopic composite behaviors based on the first identifiers, ultimately yielding data on the bird's living behaviors. For example, the first analysis pathway preferentially performs high-confidence behavior confirmation on these anchor frames. The second analysis pathway precisely locates the start and end boundaries of a specific behavior, thereby extracting the correct image frame group for micro-action analysis. The third pathway directly reads these identifiers to rapidly construct an initial behavior sequence, significantly improving the efficiency of macro-level analysis.

By way of example, suppose that within the generated image frame sequence, a clear behavioral switch from feeding to preening is detected without camera change, yet with a change in behavioral semantics. At T=14:22:10.120, the component relationship indicates head lowered with beak in contact with food, and this frame is marked with identifier ID01, behavior=feeding, type=end, camera=first camera. At T=14:22:10.850, the component relationship first indicates head raised with beak grooming wing feathers, and this frame is marked with identifier ID02, behavior=preening, type=start, camera=first camera. After the sequence carrying ID01 and ID02 enters the behavior analysis module, the second analysis pathway precisely segments the 49 frames between T=14:22:08.500 and T=14:22:10.120 as one feeding bout and performs micro-action analysis thereon, calculating that the bout contains 21 pecking strikes with an average pecking interval of 0.38 seconds. In the absence of identifiers, the second pathway would need to employ sliding windows across a sequence as long as 300 frames to search for behavior boundaries, resulting in large computational load and high risk of error. With the first identifier marking, the time required for the second pathway to locate the analysis interval is reduced by 85%, and boundary precision reaches 100%.

By switching constraints based on component relationships and extracting key single frame images, precise recognition of bird behaviors is ensured, while interference from invalid data is avoided. A first identifier effectively marks the key image frames, making the data in the behavior analysis process clearer. The marked image frames are then imported into the behavior analysis module, further optimizing the analysis workflow, reducing the computational burden of irrelevant frames, and improving both the accuracy and speed of behavior analysis.

Further, referring FIG. 6, S200 further includes: S205 performing an image frame localization on the first analysis pathway using the first identifier, and executing a behavioral semantic interpretation based on ternary geometric linear structures under the component relationships to determine a first analysis result; S206 laterally interacting the first analysis result to the second analysis pathway and the third analysis pathway, performing a targeted recognition based on micro-actions and macroscopic composite behaviors, and determining a second analysis result and a third analysis result.

Further, the second analysis pathway takes an image frame group of a single behavior as one recognition unit and performs partition parallel analysis based on a single recognition unit; the third analysis pathway performs a macroscopic grouping constraint on image frame groups based on behavior correlation and performs a partition parallel analysis based on a macroscopic grouping.

Specifically, the first analysis pathway utilizes the first identifier to perform rapid image frame localization, thereby marking key frames and enabling quick jumping to key positions in the image frame sequence instead of frame-by-frame scanning. Based on the ternary geometric linear structure of bird head-neck-beak, behavior semantic interpretation is performed to determine the specific behavior type of the bird, such as feeding, drinking, preening, vigilance, etc. The behavior semantic interpretation refers to directly determining the basic behavior type at that moment according to the static or quasi-static geometric posture of the head-neck-beak in the key frames, such as feeding, drinking, preening, vigilance, etc., and outputting discrete behavior labels. The first analysis result is the output of the first analysis pathway, typically a time-stamped basic behavior list describing which basic behavior event occurred at which moment, for example, feeding at 10:05:01.200, vigilance at 10:05:01.800.

The first analysis result is laterally interacted to the second analysis pathway and the third analysis pathway. Lateral interaction means that the analysis pathways share intermediate data and computation results directly without passing through a central controller, i.e., the first analysis result is used as common information and broadcast in real time to the second analysis pathway and the third analysis pathway.

The second analysis pathway is directionally activated. Upon receiving a new basic behavior start from the lateral interaction, it immediately extracts all frames from the start to the end of that behavior from the sequence to form a single-behavior image frame group. Partitioned parallel analysis is performed within each recognition unit, that is, each single behavior frame group is treated as one recognition unit, detailed analysis is conducted on each behavior group, and the second analysis result is obtained. Meanwhile, the third analysis pathway is also directionally activated, continuously monitors the first analysis result, and performs macro grouping constraint according to predefined behavior correlation, that is, macro-grouping image frames based on behavior correlation, merging a series of consecutive behaviors into one composite behavior for recognition, so as to understand the overall behavior pattern of the bird, such as peck-swallow-look-around being recognized as one composite behavior. Through directional recognition of macro-composite behaviors, the third analysis result is determined.

By way of example, suppose that, for an image frame sequence, the first analysis pathway outputs, within 200 ms, the semantic flow of the first 10 seconds using the first identifier: 0-2.1 s pecking, 2.1-5.3 s looking around, 5.3-6.8 s pecking, 6.8-10.0 s looking around. After receiving the first pecking unit (i.e. 2.1 seconds, 63 frames), the second analysis pathway immediately performs partitioned parallel analysis, calculates the pecking frequency as 3.2 times/second, and recognizes it as a typical rapid shallow pecking manner with a duration of 500 ms. At the same time, the third analysis pathway receives the first analysis result, detects a pattern in which short pecking averaging 1.7 s and long looking-around averaging 3.2 s repeated 15 times within 2 minutes, and at 10:15:30 outputs the third analysis result: high-intensity vigilant foraging composite behavior is recognized, under which the proportion of foraging time is only 34.7%.

Through directional recognition and partitioned parallel analysis, computational resources are allocated on demand. By employing geometric constraints of component relationships and semantic interpretation, the accuracy of behavior recognition is improved, and misrecognition caused by viewpoint changes and occlusion is avoided. The second analysis pathway and the third analysis pathway can finely capture single behaviors and continuous actions, providing rich behavior information, thereby elevating bird behavior analysis from simple event recording to a new level of behavioral strategy research.

Further, refers to FIG. 7, the S200 further includes: S207, constructing a behavior chain based on the first analysis result, the second analysis result, and the third analysis result; S208, performing the statistical analysis on the behavior chain according to statistical mining rules of behavior patterns and bird behaviors to determine bird behavior data.

Specifically, the first analysis result, the second analysis result and the third analysis result are integrated in chronological order to form a behavior chain that reflects the continuous activity of the bird. A statistical mining rule engine is activated to perform multi-dimensional and deep statistical analysis on the behavior chain, mining meaningful patterns therefrom, and determining bird behavior data. For example, a certain bird species may exhibit cautious feeding behaviors, characterized by frequent pauses during feeding to observe the surrounding environment. Whereas another bird species may exhibit a continuous feeding pattern, pecking and swallowing rapidly and consecutively.

The bird behavior data constitutes conclusional data derived from statistical analysis of behavior chains, representing a quantitative characterization of long-term, stable behavioral characteristics of an individual or population. Such data is typically presented in the form of statistical metrics and models, different behaviors exhibited by different species carry distinct ethological significances. By employing statistical mining rules on behavior chains, behavior patterns correlated with species-specific behaviors are extracted. For example: frequent pauses combined with scanning/observational behavior, together with clear intervals between pecking and resting, indicate a cautious foraging behavior. Rapid pecking with high peck frequency and absence of pauses characterizes continuous feeding behavior. Increased pecking frequency with delayed swallowing manifests as a multiple-peck-then-swallow feeding pattern. By way of illustration, suppose analysis of a behavior chain reveals that a given bird spends 65% of its foraging time scanning during morning feeding sessions, whereas only 38% of foraging time is spent scanning during midday feeding; such disparity gives rise to the bird behavior characterization of “morning high vigilance foraging.”

Through construction of behavior chains, comprehensive identification of bird behavior is achieved, thereby overcoming limitations inherent in single-behavior analysis. Species-specific behavioral characteristics enable recognition of particular behavior patterns, thus revealing both inter-individual variation and species-typical ethological characteristics.
S300, performing a periodic monitoring analysis and updating the bird behavior data, the bird behavior data that has stabilized is used as a behavior analysis result for display on a terminal interface.

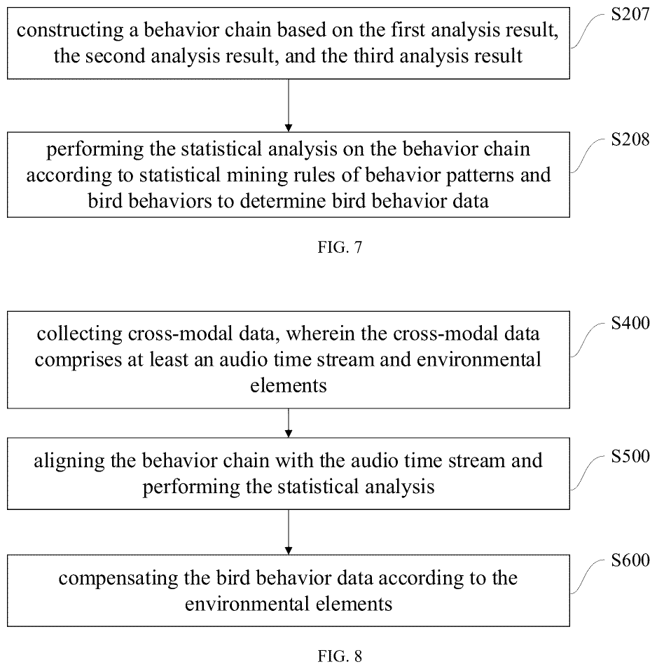

In a further embodiment, referring to FIG. 8, the analysis method further includes the steps of S400 to S600. S400 collecting cross-modal data, the cross-modal data includes at least an audio time stream and environmental elements; S500 aligning the behavior chain with the audio time stream and performing the statistical analysis; S600 compensating the bird behavior data according to the environmental elements.

More specifically, upon completion of a first analysis cycle, an initial version of bird behavior data is generated and stored in a database. Rather than terminating after a single analysis, the complete process—from data acquisition to bird behavior data generation—is repeatedly executed with a fixed period serving as one analysis unit. At the end of each cycle, the latest analysis results are fused with historical data, thereby iteratively refining and updating previously derived behavior patterns, quantitative parameters, and individual profiles.

That is, upon entering the subsequent cycle, new monitoring data are collected, the same analytical workflow is executed, and bird behavior data for the new period (e.g., the next day) are generated. Bird behavior data updating does not entail simple replacement of prior data; instead, new and historical data are fused along the time series. For instance: if pecking behavior becomes denser in the latest monitoring cycle, the feeding frequency parameter is updated accordingly; if vigilance-related behavior decreases, the caution index or equivalent metric is correspondingly adjusted.

Core behavior indicators are continuously monitored across consecutive cycles. When the magnitude of change falls below a predetermined threshold, the bird behavior data is deemed to have stabilized. By way of example, if parameter variation remains below 2% across five consecutive cycles, a final behavior analysis result is generated. The stabilized behavior data is output in structured form on the terminal interface, including but not limited to data dashboards, behavioral timelines, statistical charts, and individual behavior profile cards. For instance, taking bird A as an example with a 24-hour cycle, during a 15-day observation period, preliminary daily bird behavior data for a bird A are generated each day. A key indicator is the daily average proportion of vigilance behavior, yielding the following fluctuation sequence: day 1: 18%, day 2: 35% (due to passage of a cat), day 3: 22%, day 4: 20%, day 5: 19% (<2% change), . . . , day 10 smoothed value stabilizes at 19.5%, and from day 11 to day 15 the daily smoothed value varies by less than ±0.3%. Accordingly, the high vigilance level behavior of the bird A is determined to be stable. The final behavior analysis result is therefore generated, establishing a stable behavior profile for the bird A characterized by: average daily vigilance time proportion of 19.5%±0.3%; typical crepuscular bimodal foraging rhythm confirmed by other observed indicators; and 99% confirmation rate of the characteristic “five-peck one-swallow” fine feeding motor pattern.

Through the periodic monitoring analysis and behavior updating, interference from contingent factors is excluded, ensuring that the output behavior analysis result reflects stable behavioral traits formed after environmental adaptation, thereby endowing the analysis outcome with both stability and long-term representativeness.

Collecting cross-modal data refers to the collection of data types distinct from video surveillance, including at least an audio time stream and environmental factors. The audio time stream consists of continuous audio signals synchronously captured by microphones with precise timestamps, used to record vocalizations, wing-flapping sounds, alarm flights, and other ambient acoustic events. Environmental factors include physical parameters measured by various environmental sensors—typically including illuminance, ambient temperature, relative humidity, wind speed, precipitation, etc.—likewise timestamped.

The behavior chain, audio event stream, and environmental factors are aligned to a common absolute clock, enabling synchronous acquisition of the audio time stream and environmental factors. In other words, each event in the behavior chain is associated with the contemporaneous audio spectrum and environmental readings, e.g., determining whether scanning behavior coincides with predator vocalization or abrupt temperature drop). Through cross-modal statistical analysis, the influence of audio cues on bird behavior data is identified. For example, analysis of audio signals in the 2 seconds preceding all alarm-flight events reveals that 80% of such events contain an energy peak in a specific high-frequency band simulating a predator call, thereby confirming acoustic stimuli as one of the primary triggers of alarm flight.

Concurrently, compensation of the final bird behavior data is performed based on environmental factors and the audio time stream. When deviation in a behavior pattern arises from environmental variation or predator vocalization rather than intrinsic behavior change, appropriate numerical compensation is applied to the bird behavior data so as to prevent erroneous interpretation. For instance, at an experimental ambient temperature of 8° C., the average pecking frequency decreases by approximately 15% compared with 18° C. conditions. Such environmental effect is numerically compensated to avoid misclassifying the reduced feeding rate under low temperature as cautious feeding behavior or reduced appetite.

By aligning the behavior chain with the audio time stream for analysis, the analysis method not only records what the bird has performed, but also enables inference of the underlying reasons for such behavior, thereby establishing a correspondence between external stimuli and behavioral responses. The environmental compensation mechanism effectively decouples short-term environmental fluctuations from the overt manifestation of behavior, such that the ultimately outputted bird behavior data more faithfully represents the intrinsic behavioral characteristics of the bird itself, thereby preventing misinterpretation of weather variations or incidental disturbances as changes in behavioral habits, and consequently improving the accuracy and reliability of bird behavior analysis.

In summary, the analysis method for bird behavior based on multi-frame fusion provided in the present disclosure achieves the following technical effects. Performing a dual-channel monitoring and a frame rate fusion based on a monitoring device assembled inside a housing of a binocular bird feeder, to determine an image frame sequence, a behavior structure is defined in a lightweight geometric linear manner using a head-neck-beak of a bird as a basis for frame rate fusion; constructing a behavior analysis module using behavioral semantics, behavioral micro-actions, and macroscopic composite behaviors as recognition dimensions, performing a dimension-parallel analysis and a statistical analysis on the image frame sequence to determine bird behavior data; performing a periodic monitoring analysis and updating the bird behavior data, the bird behavior data that has stabilized is used as a behavior analysis result for display on a terminal interface. In other words, dual-channel monitoring and frame rate fusion are performed by the monitoring device, and the behavior analysis module is constructed to conduct multi-dimensional behavior patterns parsing and iterative updating on the image frame sequence, thereby improving the precision of bird behavior recognition and consequently enhancing the accuracy and reliability of bird behavior analysis.

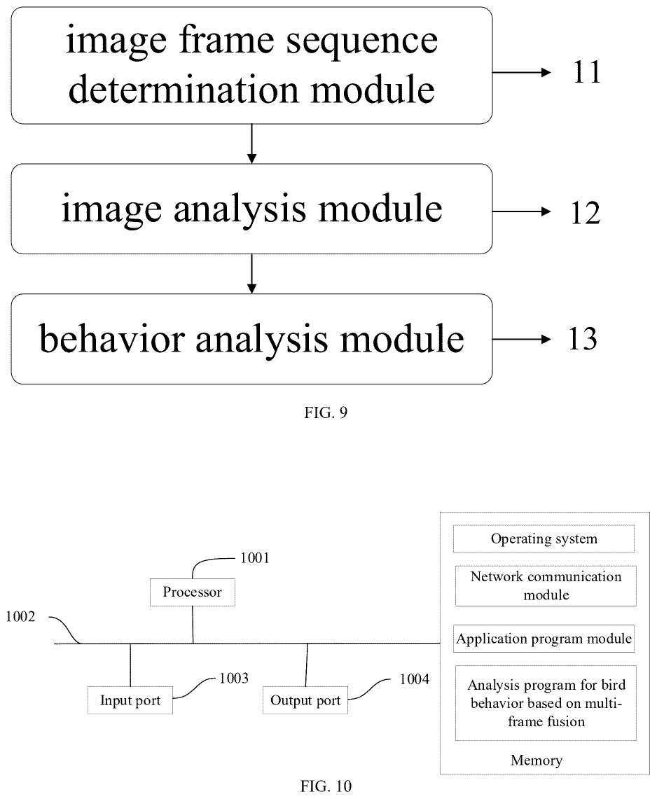

Based on the same inventive concept as the analysis method for bird behavior based on multi-frame fusion described in the foregoing embodiment, the present disclosure further provides an analysis system for bird behavior based on multi-frame fusion. Referring to FIG. 9, the analysis system includes the following modules.

An image frame sequence determination module 11, performing a dual-channel monitoring and a frame rate fusion based on a monitoring device assembled inside a housing of a binocular bird feeder, to determine an image frame sequence, a behavior structure is defined in a lightweight geometric linear manner using a head-neck-beak of the bird as a basis for frame rate fusion.

An image analysis module 12, constructing a behavior analysis module using behavioral semantics, behavioral micro-actions, and macroscopic composite behaviors as recognition dimensions, performing a dimension-parallel analysis and a statistical analysis on the image frame sequence to determine bird behavior data.

A behavior analysis module 13, performing a periodic monitoring analysis and updating the bird behavior data, the bird behavior data that has stabilized is used as a behavior an

Further, the image frame sequence determination module 11 in the analysis system for bird behavior based on multi-frame fusion is further configured for: the monitoring device includes a first camera and a second camera, with a food tray and a water tray serving as a monitoring range; performing a time-sequence synchronization constraint on the monitoring device based on an absolute clock.

Further, the image frame sequence determination module 11 is further configured for: obtaining back dual-channel image sequences acquired by the monitoring device; determining component relationships under a behavior structure constraint, the component relationships are constituted by a set of ternary geometric linear structures based on head-neck-beak constraints of different bird behaviors; establishing a frame rate fusion component based on the component relationships, performing effective frame rate screening and time-series interleaving integration on the dual-channel image sequences based on matching and switching of the component relationships, to obtain the image frame sequence.

Further, the image analysis module 12 is further configured for: constructing a first analysis pathway based on behavioral semantic recognition of component relationships; constructing a second analysis pathway based on single-behavior micro-action recognition; constructing a third analysis pathway based on macroscopic composite behavior recognition; performing a parallel processing of the first analysis pathway, the second analysis pathway, and the third analysis pathway and establishing a lateral interaction therebetween as the behavior analysis module, the behavior analysis module is set as an embedded plug-in at a backend of the binocular bird feeder.

Further, the image analysis module 12 is further configured for: marking key single frame images in the image frame sequence under switching constraints of the component relationships using a first identifier; importing the marked image frame sequence into the behavior analysis module to perform bird behavior analysis.

Further, the image analysis module 12 is further configured for: performing an image frame localization on the first analysis pathway using the first identifier, and executing a behavioral semantic interpretation based on ternary geometric linear structures under the component relationships to determine a first analysis result; laterally interacting the first analysis result to the second analysis pathway and the third analysis pathway, performing a targeted recognition based on micro-actions and macroscopic composite behaviors, and determining a second analysis result and a third analysis result.

Further, the image analysis module 12 is further configured for: the second analysis pathway takes an image frame group of a single behavior as one recognition unit and performs partition parallel analysis based on a single recognition unit; the third analysis pathway performs a macroscopic grouping constraint on image frame groups based on behavior correlation and performs a partition parallel analysis based on a macroscopic grouping.

Further, the image analysis module 12 is further configured for: constructing a behavior chain based on the first analysis result, the second analysis result, and the third analysis result; performing the statistical analysis on the behavior chain according to statistical mining rules of behavior patterns and bird behaviors to determine bird behavior data.

Further, the behavior analysis module 13 is further configured for: collecting cross-modal data, the cross-modal data includes at least an audio time stream and environmental elements; aligning the behavior chain with the audio time stream and performing the statistical analysis; compensating the bird behavior data according to the environmental elements.

The various embodiments in the present specification are described in a progressive manner, with each embodiment focusing on differences from other embodiments. The analysis method for bird behavior based on multi-frame fusion and specific examples described in the foregoing embodiments are equally applicable to the multi-screen fusion bird behavior intelligent analysis system of the present embodiment. Through the detailed description of the analysis method for bird behavior based on multi-frame fusion provided above, those skilled in the art can clearly understand the multi-screen fusion bird behavior intelligent analysis system according to the present embodiment. Therefore, for the sake of brevity of the specification, detailed description thereof is omitted herein.

The analysis device for bird behavior based on multi-frame fusion mainly involved in the embodiments of the present invention refers to a network-connectable device capable of realizing network connection. The analysis device for bird behavior based on multi-frame fusion may be a server, a cloud platform, or the like.

Referring to FIG. 10, FIG. 10 is a schematic diagram of the hardware structure of the analysis device for bird behavior based on multi-frame fusion involved in various embodiments of the present invention. In the embodiments of the present invention, the analysis device for bird behavior based on multi-frame fusion may include a processor 1001 (e.g., a central processing unit (CPU)), a communication bus 1002, an input port 1003, an output port 1004, and a memory 1005.

The communication bus 1002 is used to implement connection and communication among these components; the input port 1003 is used for data input; the output port 1004 is used for data output; and the memory 1005 may be a high-speed RAM memory or a non-volatile memory (such as a disk memory). Optionally, the memory 1005 may also be a storage device independent of the aforementioned processor 1001.

Those skilled in the art will appreciate that the hardware structure shown in FIG. 10 does not constitute a limitation on the present invention, and may include more or fewer components than those illustrated, or a combination of certain components, or different arrangements of components.

Continuing to refer to FIG. 10, the memory 1005, as a kind of readable storage medium, may include an operating system, a network communication module, an application program module, and an analysis program for bird behavior based on multi-frame fusion. In FIG. 10, the network communication module is mainly used to connect to a server and perform data communication with the server; and the processor 1001 is configured to invoke the analysis program for bird behavior based on multi-frame fusion stored in the memory 1005 and execute all steps of the analysis method for bird behavior based on multi-frame fusion.

The above description of the disclosed embodiments enables those skilled in the art to make or use the present disclosure. Various modifications to these embodiments will be readily apparent to those skilled in the art, and the general principles defined herein may be implemented in other embodiments without departing from the spirit or scope of the present disclosure. Therefore, the present disclosure is not intended to be limited to the embodiments shown herein, but is to be accorded the widest scope consistent with the principles and novel features disclosed herein.

It will be apparent to those skilled in the art that various modifications and variations can be made to the present disclosure without departing from the spirit and scope of the application. Thus, provided that such modifications and variations of the present disclosure fall within the scope of the present disclosure and its equivalents, the present disclosure is also intended to encompass such modifications and variations.

What is claimed is:

1. An analysis method for bird behavior based on multi-frame fusion, comprising:
performing a dual-channel monitoring and a frame rate fusion based on a monitoring device assembled inside a housing of a binocular bird feeder, to determine an image frame sequence, wherein a behavior structure is defined in a lightweight geometric linear manner using a head-neck-beak of a bird as a basis for frame rate fusion;
constructing a behavior analysis module using behavioral semantics, behavioral micro-actions, and macroscopic composite behaviors as recognition dimensions, performing a dimension-parallel analysis and a statistical analysis on the image frame sequence to determine bird behavior data;
performing a periodic monitoring analysis and updating the bird behavior data, the bird behavior data that has stabilized is used as a behavior analysis result for display on a terminal interface.

2. The analysis method for bird behavior based on multi-frame fusion according to claim 1, wherein the monitoring device comprises a first camera and a second camera, with a food tray and a water tray serving as a monitoring range;
wherein before performing a dual-channel monitoring and a frame rate fusion based on a monitoring device assembled inside a housing of a binocular bird feeder further comprises:
performing a time-sequence synchronization constraint on the monitoring device based on an absolute clock.

3. The analysis method for bird behavior based on multi-frame fusion according to claim 1, wherein performing a dual-channel monitoring and a frame rate fusion based on a monitoring device assembled inside a housing of a binocular bird feeder, to determine an image frame sequence comprises:
obtaining back dual-channel image sequences acquired by the monitoring device;
determining component relationships under a behavior structure constraint, wherein the component relationships are constituted by a set of ternary geometric linear structures based on head-neck-beak constraints of different bird behaviors;
establishing a frame rate fusion component based on the component relationships, performing effective frame rate screening and time-series interleaving integration on the dual-channel image sequences based on matching and switching of the component relationships, to obtain the image frame sequence.

4. The analysis method for bird behavior based on multi-frame fusion according to claim 1, wherein constructing a behavior analysis module using behavioral semantics, behavioral micro-actions, and macroscopic composite behaviors as recognition dimensions comprises:
constructing a first analysis pathway based on behavioral semantic recognition of component relationships;
constructing a second analysis pathway based on single-behavior micro-action recognition;
constructing a third analysis pathway based on macroscopic composite behavior recognition;
performing a parallel processing of the first analysis pathway, the second analysis pathway, and the third analysis pathway and establishing a lateral interaction therebetween as the behavior analysis module, wherein the behavior analysis module is set as an embedded plug-in at a backend of the binocular bird feeder.

5. The analysis method for bird behavior based on multi-frame fusion according to claim 4, wherein, before performing a periodic monitoring analysis, the analysis method for bird behavior based on multi-frame fusion further comprises:
marking key single frame images in the image frame sequence under switching constraints of the component relationships using a first identifier;
importing the marked image frame sequence into the behavior analysis module to perform bird behavior analysis.

6. The analysis method for bird behavior based on multi-frame fusion according to claim 5, wherein performing a periodic monitoring analysis comprises:
performing an image frame localization on the first analysis pathway using the first identifier, and executing a behavioral semantic interpretation based on ternary geometric linear structures under the component relationships to determine a first analysis result;
laterally interacting the first analysis result to the second analysis pathway and the third analysis pathway, performing a targeted recognition based on micro-actions and macroscopic composite behaviors, and determining a second analysis result and a third analysis result.

7. The analysis method for bird behavior based on multi-frame fusion according to claim 6, wherein the second analysis pathway takes an image frame group of a single behavior as one recognition unit and performs partition parallel analysis based on a single recognition unit;
the third analysis pathway performs a macroscopic grouping constraint on image frame groups based on behavior correlation and performs a partition parallel analysis based on a macroscopic grouping.

8. The analysis method for bird behavior based on multi-frame fusion according to claim 7, wherein performing a statistical analysis on the image frame sequence to determine bird behavior data comprises:
constructing a behavior chain based on the first analysis result, the second analysis result, and the third analysis result;
performing the statistical analysis on the behavior chain according to statistical mining rules of behavior patterns and bird behaviors to determine bird behavior data.

9. The analysis method for bird behavior based on multi-frame fusion according to claim 8, wherein the analysis method for bird behavior based on multi-frame fusion further comprises:
collecting cross-modal data, wherein the cross-modal data comprises at least an audio time stream and environmental elements;
aligning the behavior chain with the audio time stream and performing the statistical analysis;
compensating the bird behavior data according to the environmental elements.

10. An analysis system for bird behavior based on multi-frame fusion, wherein the analysis system for bird behavior based on multi-frame fusion is configured to implement the steps of the analysis method for bird behavior based on multi-frame fusion of claims 1 to 9, the analysis system for bird behavior based on multi-frame fusion comprising:
an image frame sequence determination module, performing a dual-channel monitoring and a frame rate fusion based on a monitoring device assembled inside a housing of a binocular bird feeder, to determine an image frame sequence, wherein a behavior structure is defined in a lightweight geometric linear manner using a head-neck-beak of the bird as a basis for frame rate fusion;
an image analysis module, constructing a behavior analysis module using behavioral semantics, behavioral micro-actions, and macroscopic composite behaviors as recognition dimensions, performing a dimension-parallel analysis and a statistical analysis on the image frame sequence to determine bird behavior data;
a behavior analysis module, performing a periodic monitoring analysis and updating the bird behavior data, the bird behavior data that has stabilized is used as a behavior analysis result for display on a terminal interface.

11. A non-transitory computer-readable storage medium, wherein the non-transitory computer-readable storage medium stores an analysis program for bird behavior based on multi-frame fusion, when the analysis program for bird behavior based on multi-frame fusion is executed by a processor, implements the steps of the analysis method for bird behavior based on multi-frame fusion of claims 1 to 9.
